(19) United States
(12) Patent Application Publication
(10) Pub. No.: US 2024/0195472 A1
(43) Pub. Date: Jun. 13, 2024

(54) BASEBAND UNIT, RADIO UNIT AND METHODS IN A WIRELESS COMMUNICATIONS NETWORK

(71) Applicant: Telefonaktiebolaget LM Ericsson (publ), Stockholm (SE)

(72) Inventors: Chenguang Lu, Sollentuna (SE); Yezi Huang, Taby (SE); Miguel Berg, Sollentuna (SE); Niklas Wernersson, Kungsangen (SE)

(21) Appl. No.: 18/286,311

(22) PCT Filed: Apr. 14, 2021
(86) PCT No.: PCT/SE2021/050343

§ 371 Date: Oct. 10, 2023

(51) Int. Cl. H04B 7/06; H04B 7/0417; H04B 7/0452; H04L 5/00

(52) U.S. Cl. CPC H04B 7/0617; H04B 7/0417; H04B 7/0452; H04B 7/0634; H04L 5/0023

(57) ABSTRACT

A method is provided, performed by a Baseband Unit (BBU) for assisting a Radio Unit (RU) to perform beamforming for a communication between a User Equipment (UE) and a base station in a wireless communications network using a multiple antenna system for communication. The BBU and the RU are associated with the base station. The BBU calculates (401) respective Beamforming Weights. BFWs, for at least a subset of subcarriers out of a number of subcarriers. The BBU transforms (402) by a mathematical transformation, the respective calculated BFWs, from frequency domain BFWs to obtain tap-domain BFWs. The BBU select (403) one or more tap-domain BFWs from said obtained tap-domain BFWs. The BBU sends (404) to the RU, the selected one or more the tap-domain BFWs. The selected one or more tap-domain BFWs assists the RU to perform beamforming for the communication between the CE and the base station.

### TECHNICAL FIELD

Embodiments herein relate to a Baseband Unit (BBU) a Radio Unit (RU) and methods therein. In some aspects they relate to beamforming for a communication between a User Equipment (UE) and a base station in a wireless communications network using a multiple antenna system for communication.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For the wireless connection between a single user and the base station, the performance is in particular improved if both the transmitter and the receiver are equipped with multiple antennas, which results in a Multiple-Input Multiple-Output (MIMO) communication channel. This is usually referred to as SU-MIMO (single-user MIMO). In the scenario where MIMO techniques is used for the wireless connection between multiple users and the base station, MIMO enables the users to communicate with the base station simultaneously using the same time-frequency resources by spatially separating the users, which increases further the cell capacity. This is usually referred to as MU-MIMO (multi-user MIMO). Note that MU-MIMO may benefit when each UE has one or more antennas. MU-MIMO is not limited to single-antenna UEs. It may also work with UEs with multiple antennas. Such systems and/or related techniques are commonly referred to as MIMO.

Massive MIMO techniques have first been adopted to practice in LTE. In 5G, it becomes a key technology component, which will be deployed in a much larger scale than in LTE. It features with a large number of antennas used on the Base-station (BS) side, where the number of antennas is typically much larger than the number of user-layers. A user-layer when used herein e.g. means an independent downlink or uplink data stream intended for one user. Note that one user or UE may have one or multiple user-layers. For example, 64 antennas are serving 8 or 16 user-layers in FR1, and 256/512 antennas serving 2 or 4 layers in FR2. Massive MIMO is sometimes referred to as massive beamforming (especially for higher frequency band), which is able to form narrow beams focusing on different directions to counteract against an increased path loss at higher frequency bands. It also benefits MU-MIMO which allows for transmissions from and to multiple UEs simultaneously over separate spatial channels resolved by the massive MIMO technologies, while keeping high capacity for each UE. Therefore, it significantly increases the spectrum efficiency and cell capacity.

The great benefits of massive MIMO at the air-interface also introduce new challenges at the base station side. The legacy Common Public Radio Interface (CPRI)-type fronthaul sends time-domain IQ samples per antenna branch between a BBU and an RU. The interface between the BBU and the RU is the fronthaul interface. The interface between the BBU and the CN is the backhaul interface. As the number of antennas scales up in massive MIMO systems, the required fronthaul capacity also increases proportionally, which significantly drives up the fronthaul costs. To address this challenge, different Lower-Layer Split (LLS) options have been adopted. The basic idea is to move beamforming function from the BBU to the RU, so that frequency samples or data of user-layers are transported over the fronthaul interface. Therefore, a variety of LLS options reduce the number of fronthaul streams from the number of antennas to the number of user-layers.

### SUMMARY

As a part of developing embodiments herein a problem was identified by the inventors and will first be discussed.

Although the LLS architecture solves the problem of fronthaul limitation on user plane, problem still exists in control plane when the channel estimation is performed at BBU whereas beamforming is conducted at RU.

A control plane is the part of a network which carries information necessary to establish and control the network, while a user plane carries information regarding the network user traffic.

In some LLS options, e.g. O-RAN LLS (aka O-RAN Open Fronthaul, from O-RAN Alliance Working Group 4), Beamforming Weights (BFWs) calculations are conducted at BBU (in O-RAN called O-DU for O-RAN Distributed Unit). This is applicable to both DL and UL. In this case, the BFWs needs to be transported over the fronthaul interface to the RU (in O-RAN called O-RU for O-RAN Radio Unit). Note that the amount of BFWs is still proportional to the number of antennas. As a result, a large amount of control-plane data including BFWs needs to be transported via the fronthaul interface, typically in a much shorter time window than that for user-plane data since some time is needed for BFW calculation. This drives up the fronthaul peak rate, as illustrated in FIG. 1. FIG. 1 illustrates high burst fronthaul traffic due to BFWs. Such burst traffic requires for high fronthaul capacity, which will only be fully loaded for a short period of time now and then.

Thus, it is desirable to compress the BFWs before transporting them over the fronthaul interface. One existing solution groups the subcarriers of scheduled bandwidth into Subcarrier Groups (SCGs). Each SCG comprises one or multiple resource blocks (RBs). For each SCG, BFWs on only one subcarrier is calculated at BBU and transported to the RU. This not only reduces the amount of BFWs to be transported but also reduces the complexity of BFW calculation. In this case, the compression ratio equals the number of subcarriers in an SCG. At RU, the received BFWs calculated on certain subcarrier will be shared over other subcarriers in the same SCG. However, such BFWs compression constrained by the fronthaul capacity is achieved at the cost of beamforming performance degradation, e.g. resulting in lower SINR, due to the mismatch of the channel coefficients on some subcarriers and the BFWs used, especially when the channel variation in frequency-domain is large among subcarriers in the same SCG.

An object of embodiments herein is to improve beamforming performance of a wireless communications network using beamforming.

According to an aspect of embodiments herein, the object is achieved by a method performed by a Baseband Unit, BBU, for assisting a Radio Unit, RU, to perform beamforming for a communication between a User Equipment, UE, and a base station 110 in a wireless communications network using a multiple antenna system for communication. The BBU and the RU are associated with the base station. The BBU calculates respective Beamforming Weights, BFWs, for at least a subset of subcarriers out of a number of subcarriers. The BBU transforms by a mathematical transformation, the respective calculated BFWs, from frequency domain BFWs to obtain tap-domain BFWs. The BBU selects one or more tap-domain BFWs from said obtained tap-domain BFWs. The BBU then sends to the RU, the selected one or more the tap-domain BFWs. The selected one or more tap-domain BFWs assists the RU to perform beamforming for the communication between the UE and the base station.

According to another aspect of embodiments herein, the object is achieved by a method performed by a Radio Unit, RU, for performing beamforming for a communication between a User Equipment, UE, and a base station in a wireless communications network using a multiple antenna system for communication. The RU is associated with the base station. The RU receives from a Base Band Unit, BBU, associated with the base station, one or more tap-domain BFWs selected by the BBU. The RU reconstructs tap-domain BFWs based on the selected one or more tap-domain BFWs. The RU transforms by a mathematical transformation, at least some of the reconstructed tap-domain BFWs of the one or more tap-domain BFWs, to obtain corresponding frequency domain BFWs related to respective subcarriers out of a number of subcarriers. The RU then performs beamforming with the obtained frequency domain BFWs on the respective subcarriers out of the number of subcarriers for the communication between the UE and the base station.

According to another aspect of embodiments herein, the object is achieved by a Baseband Unit, BBU, configured to assist a Radio Unit, RU, to perform beamforming for a communication between a User Equipment, UE, and a base station in a wireless communications network using a multiple antenna system for communication. The BBU and the RU are adapted to be associated with the base station. The BBU is further configured to:
calculate respective Beamforming Weights, BFWs, for at least a subset of subcarriers out of a number of subcarriers, and
transform by a mathematical transformation, the respective calculated BFWs, from frequency domain BFWs to obtain tap-domain BFWs,
select one or more tap-domain BFWs from said obtained tap-domain BFWs, and
send to the RU, the selected one or more the tap-domain BFWs, which selected one or more tap-domain BFWs is adapted to assist the RU to perform beamforming for the communication between the UE and the base station.

According to another aspect of embodiments herein, the object is achieved by a Radio Unit, RU, configured to perform beamforming for a communication between a User Equipment, UE, and a base station in a wireless communications network using a multiple antenna system for communication. The RU is adapted to be associated with the base station. The RU is further configured to:
receive from a Base Band Unit, BBU, adapted to be associated with the base station, one or more tap-domain BFWs selected by the BBU,
reconstruct tap-domain BFWs based on the selected one or more tap-domain BFWs,
transform by a mathematical transformation, at least some of the reconstructed tap-domain BFWs of the one or more tap-domain BFWs, to obtain corresponding frequency domain BFWs adapted to be related to respective subcarriers out of a number of subcarriers,
perform beamforming with the obtained frequency domain BFWs on the respective subcarriers out of the number of subcarriers for the communication between the UE and the base station.

Since the BBU sends the selected one or more tap-domain BFWs to the RU, which means over the fronthaul, the amount of transported BFWs will be significantly reduced resulting in less bit rate required for fronthaul, while beamforming performance is kept on parity with the case without BFW reduction. Alternatively, for a same amount of transported BFWs, using the selected tap-domain BFWs instead of frequency-domain BFWs, results in improved performance of the wireless communications network when using beamforming.

### BRIEF DESCRIPTION OF THE DRAWINGS

Examples of embodiments herein are described in more detail with reference to attached drawings in which:

FIG. 1 is a schematic diagram illustrating prior art.

FIG. 2 is a schematic block diagram illustrating embodiments of a wireless communications network.

FIG. 3 is a sequence diagram depicting embodiments herein.

FIG. 4 is a flowchart depicting embodiments of a method in a BBU.

FIG. 5 is a flowchart depicting embodiments of a method in an RU.

FIG. 6 is a diagram illustrating an example embodiment herein.

FIG. 7 is a diagram illustrating an example embodiment herein.

FIG. 8 is a diagram illustrating an example embodiment herein.

FIG. 9 is a diagram illustrating an example embodiment herein.

FIG. 10a-b are schematic block diagrams illustrating embodiments of a BBU.

FIG. 11a-b are schematic block diagrams illustrating embodiments of an RU.

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14-17 are flowcharts illustrating methods implemented in a communication system including a host computer, a base station and a user equipment.

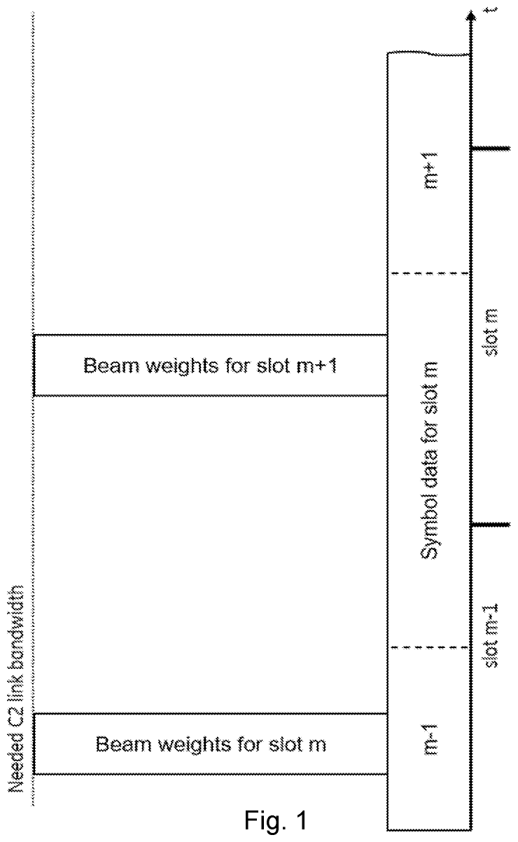

### DETAILED DESCRIPTION

As mentioned above, as a part of developing embodiments herein a problem was identified by the inventors which now will be further discussed.

For the O-RAN LLS architecture, channel estimation based on UL reference signals, e.g. Sounding Reference Signal (SRS), and BFW calculation are done in a BBU. Then the BBU transports the BFWs to the RU. The RU receives the BFWs and use the BFWs to execute downlink (DL) or uplink (UL) beamforming.

Consider a scenario with K user-layers in a desired cell and the base station is composed of N antenna elements. In 5G, it typically has N>>K. As the beamforming is done in the RU, the amount of fronthaul user-plane data becomes only proportional to the number of layers, i.e., K, whereas the BFWs composed by N×K elements still scale both with the number of layers (K) and the number of antennas (N) on each subcarrier for each slot. Especially in environments with high mobility and/or varying interference, lifetime of BFWs is short, which introduces latency restrictions. When transporting BFWs over the fronthaul interface, traffic becomes bursty, which requires high fronthaul capacity.

One existing solution is to reduce the amount of BFWs to be transported by only sending BFWs on one subcarrier (usually the middle one) in one SCG where each SCG contains one or multiple RBs. At RU, the received BFWs on one subcarrier will be used by all subcarriers in the SCG. This method is referred to as reference method hereinafter.

A higher reduction on the required fronthaul capacity can be achieved by using a larger SCG size, but the beamforming performance will be degraded since the difference between the received BFWs and the desired BFWs on other subcarriers of the SCG would become larger. Let a K×N complex matrix H with K rows and N columns of complex values denote the DL channel on one subcarrier and the corresponding BFWs is denoted as an N×K complex matrix W with N rows and K columns of complex values.

The wording element-domain when used herein e.g. means a referred quantity such as signal, channel, BFW etc. being associated with each of the antenna elements at the RU. The concept of an antenna element is non-limiting in the sense that it can refer to any virtualization, e.g., linear mapping, of a transmitted signal to the physical antenna elements. For example, groups of physical antenna elements may in case of a DL transmission be fed the same signal, and hence they share the same virtualized antenna port when observed at the receiver. Hence, the receiver cannot distinguish and measure the channel from each individual antenna element within the group of element that are virtualized together. In a similar manner the concept of an antenna element is non-limiting also when related to an UL reception; here any virtualization can be applied to the physical antenna elements to generate one received signal corresponding to an antenna element.

The wording beam-domain when used herein e.g. means a referred quantity such as signal, channel, BFW etc. signal being associated with each of some predefined beams. For example, a set of signals, received or transmitted, corresponding to a set of antenna elements may be transformed to the beam domain by applying a virtualization, e.g., linear mapping, to the set of signals. This virtualization produces a second set of signals and these signals are in the beam domain. Depending on the design of the virtualization the second set of signals may correspond to one beam or multiple beams. The properties of these beams will in turn depend on the virtualization.

The wording frequency-domain when used herein e.g. means the referred quantity such as signal, channel, BFW etc. being defined at different frequencies. For example, the concept of a signal, either in the element-domain or beam-domain, is non-limiting in the sense that it may refer a multidimensional signal where each dimension corresponds to one frequency. A signal transmitted, or received, at e.g. an antenna element may for instance imply that K signals are transmitted, or received, where each of the K signals corresponds to a certain frequency.

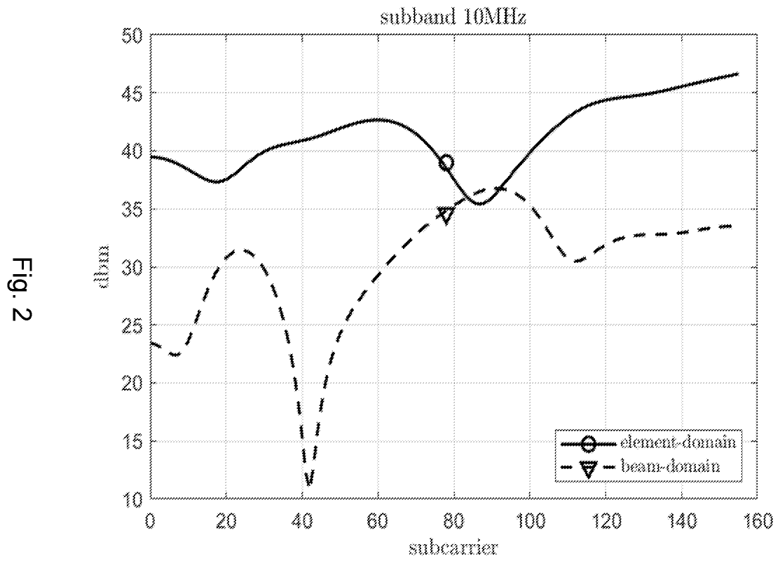

FIG. 2 depicts an example of the power of frequency domain BFWs of one path between a UE antenna and an antenna or a beam at the base station along the subcarriers within a continuous bandwidth. It exemplifies the power of one element of W along the subcarriers. The circle-marked line shows the result if the associated W is in the element-domain, whereas the triangle-marked line shows the result if the associated W is in the beam-domain.

It is observed that having uniform subsampling in the frequency-domain may work well with acceptable performance losses when the BFWs don't vary much in the neighborhood. But it would lead to more mismatches between the received BFWs of one subcarrier and the channel of the other subcarriers, which thereby further degrades the beamforming performance.

As mentioned above, an object of embodiments herein is to improve the performance of a wireless communications network using beamforming.

The wording channel value, also referred to as channel data, when used herein e.g. means one or a set of complex values representing the amplitude and phase of the channel coefficients in frequency domain. The channel values are related to the frequency response of the wireless channel. The wording channel information, when used herein, e.g., means the information about channel properties carried by the channel values.

The wording tap-domain channel when used herein e.g. means frequency-domain channel coefficients are transferred to channel taps by a mathematical transformation, such as DCT, DFT etc. Each channel tap corresponds to a multi-path component of the wireless channel, resolved by the system, e.g. sample rate and transformation size etc. Each channel tap is a complex value, representing the amplitude and phase of the resolved multi-path component of the wireless channel. The channel taps are related to the impulse response of the wireless channel.

A beam when used herein e.g. means a directional beam formed by multiplying a signal with different weights, in frequency-domain, at multiple antennas such that the energy of the signal is concentrated to a certain direction.

Beamforming when used herein e.g. means a technique which multiplying a signal with different weights (in frequency-domain) at multiple antennas, which would cause the signal energy sent to space according to a wanted beam pattern to form a directional beam to concentrate to certain direction or form nulling to certain direction, or the combination of two.

The wording frequency-domain BFWs when used herein e.g. means BFWs calculated based on channel values in frequency domain. Frequency domain BFWs are used to perform frequency domain beamforming, as described above. The frequency-domain BFWs comprise a set of values and there may exist one or many subsets of the values where each subset comprises multiple values. Each subset will in turn correspond to one antenna element, or one beam, and each value in this subset will correspond to one frequency.

The wording tap-domain BFWs when used herein e.g. means frequency-domain BFWs that are transformed into a new domain by a mathematical transformation, such as DCT, DFT, etc. The term of tap-domain BFWs used here takes the analogy of the relation between the frequency-domain channel and the tap-domain channel where the tap domain channel is obtained by transforming the frequency-domain channel e.g. by DFT or DCT. Note that the tap-domain BFWs are not calculated from the tap-domain channel data. The frequency domain BFWs may first be calculated based on the frequency channel data and then calculate the tap-domain BFWs from transformation of the frequency-domain BFWs The tap-domain BFWs may comprise a set of values and there may exist one or many subsets where each subset corresponds to multiple values. Each subset will in turn correspond to one antenna element, or one beam, and each value may be obtained from the transformation of frequency-domain BFWs.

A BFW tap when used herein e.g. means each BFW value obtained from the mathematical transformation, e.g. DCT or DFT, of frequency-domain BFWs. It is referred to the value of a tap-domain BFW for a given antenna element, or beam, after the mathematical transformation of the frequency domain BFWs.

Examples of embodiments herein provide a method wherein tap-domain BFWs are transmitted from a BBU to an RU over the fronthaul.

In some examples of embodiments herein it is provided a method to compress BFWs and improve the performance. This is achieved by the BBU transforming the BFWs to their tap-domain representation and transmitting to the RU, only one or more selected tap-domain BFWs for compression purpose.

To improve beamforming performance at the RU, one option is that BBU may calculate BFWs on more than one subcarrier in an SCG. Then the calculated BFWs may be transformed to tap-domain which will be compressed such that the required fronthaul capacity will not be more than directly transporting BFW on one subcarrier per SCG.

After receiving tap-domain BFWs, the RU may in some embodiments fill zeros and/or pad more zeros on the unselected BFW taps to the received tap-domain BFW. Then further, perform zero-padding when to reconstruct the tap-domain BFWs before transforming the BFWs back to frequency-domain. This is to further improve the beamforming performance.

The embodiments herein e.g. provide the following advantages:

BFWs transformed e.g. by DCT or DFT to tap-domain has the energy concentrated in a limited number of taps or elements. According to some embodiments herein, when the number of taps is large after transformation, there are more small values present in the tap-domain BFWs. In this case, the BFWs are compressed by selecting taps with larger magnitude such that the transported tap-domain BFWs are fewer than the frequency-domain BFWs before transformation. From performance perspective, it may achieve better performance than the prior art of frequency-domain subsampling approach with a better compression, transporting BFWs on more subcarriers with the same amount of fronthaul load. It is because the selected taps contain more information regarding BFW and therefore the RU obtains better knowledge of the BFWs over different subcarriers, which improves the performance.

When the number of taps is low after transformation, there may not be any small enough values which can be removed without affecting the performance negatively. In this case, all tap-domain BFWs may be transmitted from the BBU to the RU. Then, the RU which then performs interpolation, such as e.g., zero-padding, by padding more zeros based on the received tap-domain BFWs before transforming the BFWs back to frequency-domain. In this way, after transformation, more BFWs are obtained on more subcarriers. This is sometimes referred to as transform-based interpolation. It may be observed that the performance can be improved by such interpolation especially for high SNR channel condition, because the interpolated BFWs may be more accurate than using the same BFWs for the whole SCG.

Another advantage is that the compression may be adaptive according to an magnitude threshold for selecting the number of taps. Then the required fronthaul capacity will adapt to the actual channel delay spread, while the prior art approach is usually fixed, which may over- or under-compress the BFWs. This benefits for e.g. networked fronthaul where the fronthaul traffic from multiple cells are aggregated over an Ethernet network.

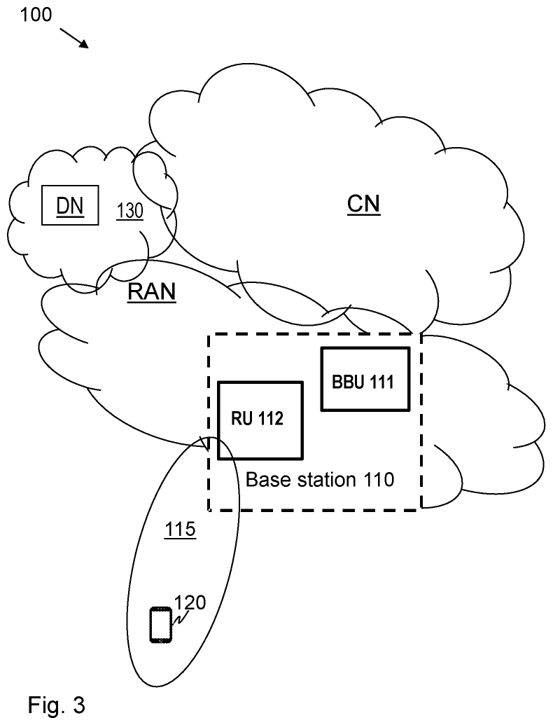

FIG. 3 is a schematic overview depicting a wireless communications network 100 wherein embodiments herein may be implemented. The wireless communications network 100 comprises one or more RANs, and one or more CNs. The wireless communications network 100, the RAN and the CN may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a base station 110. The base station 110 comprises a BBU 111 and a RU 112, also referred to as the base station 110 is associated to the BBU 111 and the RU 112. The base station 110 provides radio coverage in a number of cells which may also be referred to as a sector or a group of sectors, such as a cell 115 provided by the base station 110. The base station 110 uses a multiple antenna system such as e.g. MIMO, massive MIMO, also referred to as massive beamforming, or Single-Input Multiple-Output (SIMO) for communication.

The base station 110, may be any of a radio network node, NG-RAN node, a transmission and reception point e.g. a base station, a TRP, a radio access network node, a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a UE such as UE 120, within a service area served by the base station 110, depending e.g. on the first radio access technology and terminology used. The base station 110 may be referred to as a serving radio network node and communicates with the UE 120 with Downlink (DL) transmissions to the UE 120 and Uplink (UL) transmissions from the UE 120.

One or more UEs operate in the wireless communications network 100, such as e.g. the UE 120. The UE 120 may also referred to as a device, an IoT device, a mobile station, a non-access point (non-AP) STA, a STA, a user equipment and/or a wireless terminals, communicate via one or more Access Networks (AN), e.g. RAN, to one or more CNs. It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell. The UE 120 is in some example scenarios served by the base station 110 in the cell 115.

Methods herein may be performed by the BBU 111 and the RU 112. As an alternative, a Distributed Node (DN) and functionality, e.g. comprised in a cloud 130 as shown in FIG. 3, may be used for performing or partly performing the methods herein.

The above described problem is addressed in a number of embodiments, some of which may be seen as alternatives, while some may be used in combination.

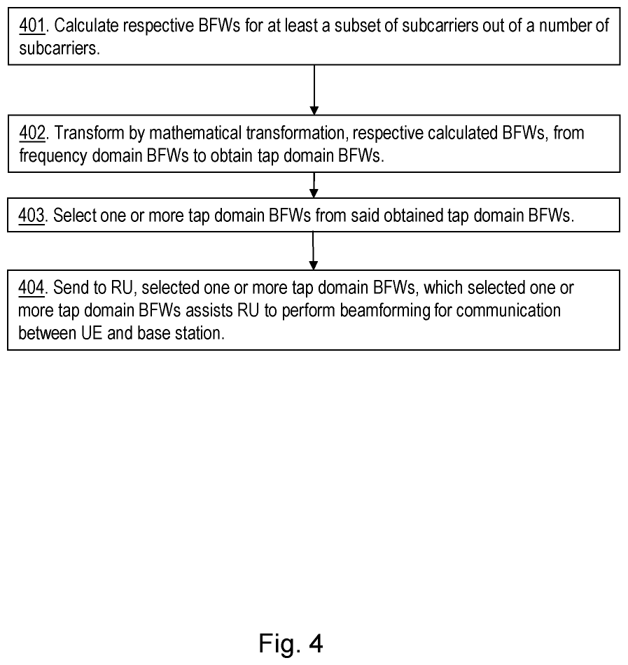

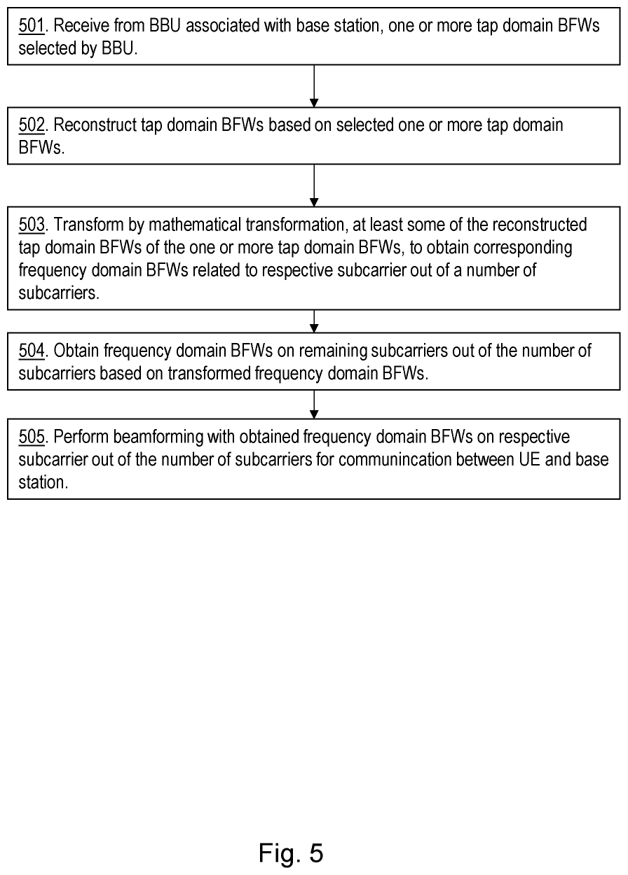

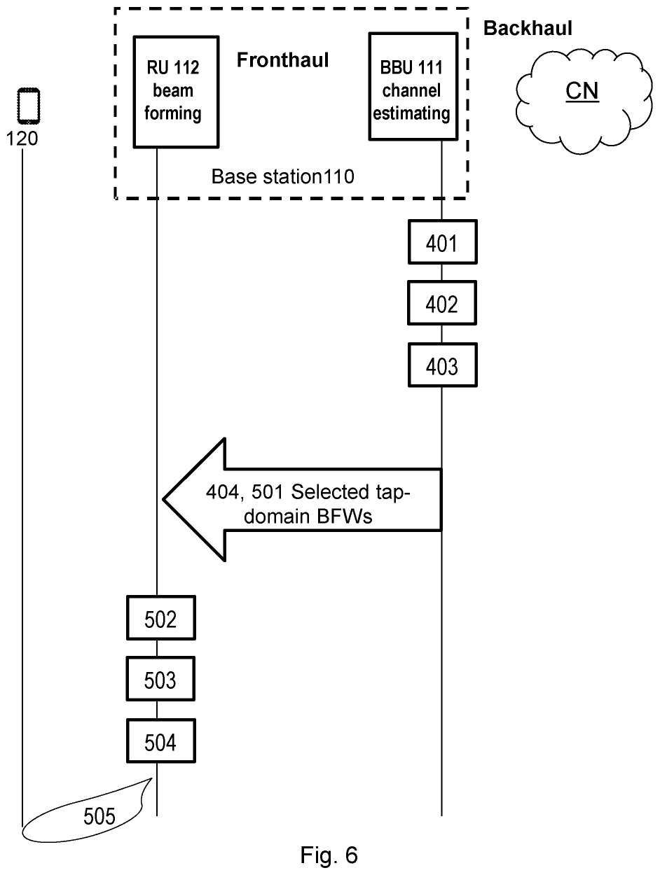

FIG. 4 shows example embodiments of a first part of the method as seen in a view of the BBU 111, and FIG. 5 shows example embodiments of a second part of the method as seen in a view of the RU 112. FIG. 6 shows a sequence diagram of example embodiments of the first and second part of the method performed by the BBU 111 and the RU 112.

The BBU 111 assists the RU 112 to perform beamforming, and the RU 112 performs the beamforming assisted by the BBU 111. The beamforming is for a communication between the UE 120 and the base station 110 in the wireless communications network 100.

The text described below in relation to FIG. 4 shall preferably be read together with both FIG. 4 and FIG. 6, and the text described below in relation to FIG. 5 shall preferably be read together with both FIG. 5 and FIG. 6.

FIG. 4 shows example embodiments of a method performed by the BBU 111 assisting the RU 112 to perform beamforming for a communication between the UE 120 and the base station 110 in a wireless communications network 100 using a multiple antenna system for communication. The multiple antenna system may e.g. be any of MIMO, massive MIMO, and SIMO. The BBU 111 and the RU 112 are associated with the base station 110.

The method comprises the following actions, which actions may be taken in any suitable order. Optional actions are referred to as dashed boxes in FIG. 4.

Referring to FIG. 4 and FIG. 6:

### Action 401

The BBU 111 calculates respective Beamforming Weights, BFWs, for at least a subset of subcarriers out of a number of subcarriers. The number of subcarriers may refer to a set of subcarriers in Orthogonal Frequency Division Multiplexing (OFDM) which are scheduled to be transmitted. The at least a subset of subcarriers may refer to subcarriers on which respective estimated channel data is available. For example, the subset of the subcarriers may refer to the middle subcarrier in each SCG.

The subset of subcarriers may comprise subcarriers for which respective estimated channel data is available.

### Action 402

The BBU 111 transforms the respective calculated BFW by a mathematical transformation. The respective calculated BFW, are transformed from frequency domain BFWs to obtain tap-domain BFWs. The mathematical transformation may e.g. DFT, or DCT, which both have good energy compacting properties.

### Action 403

The BBU 111 selects one or more tap-domain BFWs from said obtained tap-domain BFWs. This means that in some embodiments all obtained tap-domain BFWs are selected. In some alternative embodiments only some of the obtained tap-domain BFWs are selected, this is e.g. to reduce the required fronthaul capacity for transporting BFWs when the number of taps is large after transformation, and there are more small values present in the tap-domain BFWs that can be removed without noticeably impact the beamforming performance By removing some of the values it will hence be possible to reduce the required fronthaul capacity at a limited cost in terms of performance degradation. In the case when e.g. small tap-domain BFWs are removed only a small impact on the performance can be expected and the invention can consequently be used to trade fronthaul cost vs. system performance.

The number of tap-domain BFWs of the selected one or more tap-domain BFWs, may be selected based on a trade-off between being large enough to comprise significant tap-domain BFWs, and being low enough to save fronthaul capacity.

In some embodiments, the selected one or more tap-domain BFWs are selected to comprise tap-domain BFWs with the largest magnitude.

### Action 404

The BBU 111 then sends the selected one or more the tap-domain BFWs to the RU 112. The selected one or more tap-domain BFWs will assist the RU 112 to perform beamforming for the communication between the UE 120 and the base station 110.

The sending to the RU 112 may further comprise information identifying the selected one or more tap-domain BFWs. The information identifying the selected one or more tap-domain BFWs further assist the RU 112 to perform beamforming for the communication between the UE 120 and the base station 110.

FIG. 5 shows example embodiments of a method performed by the RU 112 for performing beamforming for a communication between the UE 120 and the base station 110 in the wireless communications network 100. The wireless communications network 100 uses a multiple antenna system for communication. The RU 112 is associated with the base station 110.

The method comprises the following actions, which actions may be taken in any suitable order. Optional actions are referred to as dashed boxes in FIG. 5.

Referring to FIG. 5 and FIG. 6:

### Action 501

The RU 112 receives the one or more tap-domain BFWs from the BBU 111 associated with the base station 110. As mentioned above, the one or more tap-domain BFWs are selected by the BBU 111.

According to some embodiments herein, the RU 112 further receives information identifying the selected one or more tap-domain BFWs.

### Action 502

The RU 112 reconstructs tap-domain BFWs based on the selected one or more tap-domain BFWs. This may e.g. be performed by filling zeros according to the received information identifying the selected BFWs and/or filling zeros, or pad zeros, in the end of the tap-domain BFWs.

As mentioned in Action 501, the RU 112 may further have received information identifying the selected one or more tap-domain BFWs. In these embodiments, the RU 112 may reconstruct the tap-domain BFWs further based on the information identifying the selected one or more tap-domain BFWs. This may e.g. be performed when only some tap-domain BFWs are selected, to point out on which BFW taps they are located.

As mentioned above, in some embodiments, the reconstructing of the tap-domain BFWs of the selected one or more tap-domain BFWs may further comprise any one or more out of: Filling zeros at the positions of frequency domain BFWs that are unselected according to the received information identifying the selected one or more tap-domain BFWs, and filling zeros at in the end of the tap-domain BFWs. Filling zeros (or padding zeros) at the end of the tap-domain BFWs is e.g. to obtain more frequency-domain BFWs after the transforming in Action 503 below and potentially improve performance

### Action 503

The RU 112 transforms by a mathematical transformation, at least some of the reconstructed tap-domain BFWs of the one or more tap-domain BFWs. This is to obtain corresponding frequency domain BFWs related to respective subcarriers out of a number of subcarriers. These subcarriers e.g. referred to as a subset of subcarriers may be same or different subset of subcarriers as the ones mentioned in Action 401. When additional zero-padding at the end of tap-domain BFWs is used, more frequency-domain BFWs may be produced by the transforming in Action 503 below.

### Action 504

In some embodiments, when frequency domain BFWs on all subcarriers has not been obtained, the RU 112 may obtain frequency domain BFWs on the remaining subcarriers out of the number of subcarriers based on the transformed frequency domain BFWs.

The obtaining of the frequency domain BFWs on the remaining subcarriers out of the number of subcarriers based on the transformed frequency domain BFWs, may be performed by any one or more out of:

(i) Repeating the corresponding frequency domain BFWs on neighboring subcarriers. This may be performed using a simple zero-order hold filter or similar approaches.

(ii) Interpolating the corresponding frequency domain BFWs. This may be performed using a well-known interpolation techniques like e.g. linear interpolation, cubic interpolation, splines etc.

(iii) Combining (i) and (ii) by partial interpolation and then repeating on neighboring subcarriers. This is performed by combination of the two methods described above.

### Action 505

The RU 112 then performs beamforming with the obtained frequency domain BFWs on the respective subcarriers out of the number of subcarriers for the communication between the UE 120 and the base station 110.

In this way, the BFWs have been compressed when transmitting them over the fronthaul when some taps are selected in BBU, also possible to result in an improved performance when more BFWs are obtained on more subcarriers by padding zeros in the end of tap-domain BFWs in RU, comparing to a prior art of transporting frequency-domain BFWs on one subcarrier per SCG.

As mentioned above, FIG. 6 shows example embodiments of a method for performing beamforming for a communication between the UE 120 and the base station 110 in the wireless communications network 100. The method may comprise the actions 401-404, and 501-505 described above.

The above embodiments will now be further explained and exemplified below. The embodiments below may be combined with any suitable embodiment above.

### BFWs Representation in Tap-Domain

For the LLS architecture considered according to embodiments herein, channel estimation based on UL reference signals, e.g. Sounding Reference Signal (SRS), and BFW calculation are done in BBU. Then BBU transports the BFWs to the RU. The RU receives the BFWs and use the BFWs to execute downlink (DL) or uplink (UL) beamforming.

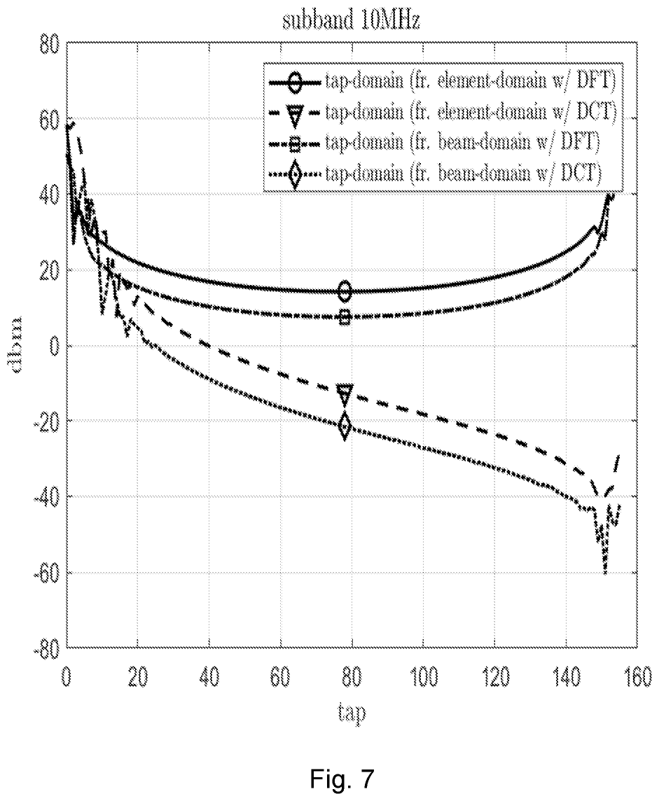

According to some embodiments herein, BFWs in tap-domain are explored instead of in the frequency-domain. It is observed that some transforms, for example, discrete Fourier transform (DFT), or discrete cosine transform (DCT) have good energy compacting properties. After the transformation of DFT or DCT, the frequency domain BFWs are transformed to the tap-domain BFWs. In the tap-domain, the BFW energy is concentrated in a limited number of taps. FIG. 7 exemplifies the power of the same W element as in FIG. 2 but along BFW taps after conducting certain Fourier transform. FIG. 7 depicts an example of BFWs power of one path along BFW taps.

The circle-marked line shows results of tap-domain BFWs transformed by DFT from frequency-domain BFWs in element-domain. The triangle-marked line shows results of tap-domain BFWs transformed by DCT from frequency-domain BFWs in element-domain. E.g. either element domain or beam domain BFWs refer to frequency domain BFWs. Element domain and beam domain refer to the spatial space, while frequency domain refer to the frequency space. The square-marked line shows results of tap-domain BFWs transformed by DFT from frequency-domain BFWs in beam-domain. The diamond-marked line shows results of tap-domain BFWs transformed by DCT from frequency-domain BFWs data in beam-domain. It may be observed that the BFW element energy concentrates on a few taps in all four cases. In this example, DCT compacts the weights energy better than DFT, and transforms from beam-domain compacts the weights energy better than that from element-domain.

The tap-domain BFWs power of one path along the BFW taps in FIG. 7 shows that tap-domain BFW energy concentrates on a limited number of BFW taps while BFW energy on the remaining BFW taps is significantly lower. Removing those small values may still maintain a large portion of information related to the BFWs.

Therefore, according to some examples of embodiments herein, the BBU 111 performs BFWs compression by selecting a subset of taps of BFWs, also referred to as tap-domain BFWs, typically some of the strongest ones. The selected tap-domain BFWs are then transmitted from the BBU 111 to RU 112. In this way, similar performance with higher BFW compression is achieved since the selected tap domain BFWs, comprises most of the information regarding BFWs.

Examples of some Actions according to embodiments herein:

Consider the scenario with K user-layers in a desired cell communicating with a base station, such as the base station 110, equipped with N antennas. The channel data may either be in UL or DL.

### Example Methods at the BBU 111

The BBU 111 optionally performs beam selection of beam-domain channel on each subcarrier.
The BBU 111 calculates BFWs on some, e.g. subsampled subcarriers, or all subcarriers where the estimated channel data is available. This action is related to Action 401 described above.
   A subcarrier index on which the BFWs are calculated may be determined by a scheduler and/or a beamforming control module which calculates the BFWs.
The BBU 111 transforms the calculated BFWs from frequency-domain to tap-domain by a mathematical transformation, such as e.g. DFT or DCT, where a length for transformation may be determined by a scheduler and/or a beamforming control module. A length for transformation when used herein, e.g. means the size of DFT or DCT to transform BFWs from frequency-domain to tap-domain. This action is related to Action 402 described above.
   The transformation is performed regarding L subcarriers of each BFW entry, i.e. wᵢⱼ, which represents the weight at the i-th row and j-th column of a BFW matrix W. For DL beamforming, i=1, . . . , N and j=1, . . . , K. For UL beamforming, i=1, . . . , K and j=1, . . . , N.
The BBU 111 selects M taps of the tap-domain BFWs, to be transmitted from the BBU 111 to the RU 112. This is also referred to as the BBU 111 selects M tap domain BFWs from the obtained tap domain BFWs. Information of the tap selection may be noted, for example, with a bitmask or tap indices. This action is related to Action 403 described above.
   The M selected taps may be those with the largest magnitude which represents most of the BFW information. In this case, the transported tap-domain BFWs are fewer than the frequency-domain BFWs before transformation. Therefore, the BFW data are compressed and the required front-haul capacity is reduced.
   The value of M may be different for different BFW entries. This e.g. means that the number of selected taps for BFW entry wᵢⱼ may be different from the number of selected taps for BFW entry wₘₙ when i≠m or j≠n.
   The number of selected taps may be equal to the total number of transformed taps. It means that all tap-domain BFWs after transformation are kept. This is especially useful when the number of taps is small, for example, 8 taps, where no small BFWs can be removed without affecting performance negatively. In this case, the scheduled bandwidth for the involved users, such as the UE 120, are small.
The BBU 111 transmits, also referred to as sends, the information of selected tap-domain BFWs possibly together with the information regarding the selected taps to the RU 112. This action is related to Action 404 described above.

### Example Methods at the RU 112

The RU 112 receives the selected one or more tap-domain BFWs possibly together with information identifying the selected one or more tap domain BFWs, also referred to as information of tap selection. Further and optionally it may receive information of beam selection. This action is related to Action 501 described above.
   In some embodiments, the information of the selection is provided in a joint tap-beam domain. A joint tap-beam domain when used herein e.g. means a BFW represented both in tap and beam domains.
   In some other embodiments, the information of the tap-domain selection and beam-domain selection are provided separately. This is e.g. when the tap-domain selection is performed after the beam-domain selection has been completed or the beam-domain selection is performed after the tap-domain selection has been completed.
The RU 112 reconstructs the BFWs in tap-domain by using the received information of BFWs and optionally information of tap selection. This action is related to Action 502 described above.
   The reconstruction may be performed by filling zeros among the received non-zero BFWs according to the received information regarding the selected taps, e.g. bitmask or tap indices.
   In addition, the reconstruction may also pad more zeros in the end of the received tap-domain BFWs. This is to obtain more BFWs on more subcarriers after the transformation back to frequency domain in the next step. This is sometimes referred to as transform-based interpolation.
The RU 112 transforms the tap-domain BFWs back to frequency-domain with the corresponding inverse transformation, for example, IDFT or IDCT, and obtains BFWs on some or all subcarriers. This action is related to Action 503 described above.
   If beam-domain BFWs are obtained, one embodiment is to transform them back to element-domain.
   If beam-domain BFWs are obtained, another embodiment is to apply them on the DL or UL signals and transform the beamformed signals back to element-domain.
   The output length of inverse transformation may be equal to or larger than the number of the tap-domain BFWs calculated in the BBU 112. As explained in the reconstruction step above, when zero padding with more zeros, it will result in that the length of inverse transformation is larger and more frequency-domain BFWs are produced. These more frequency-domain BFWs may be used for more subcarriers in each SCG, which will improve the performance yet more.
If not BFWs on all subcarriers has been obtained, the RU 112 may determine BFWs on the remaining subcarriers based on the BFWs after the inverse transformation. This action is related to Action 504 described above. This action may be done regarding BFWs either in beam-domain or element-domain.
   BFWs on the remaining subcarriers may be obtained by repeating the calculated BFWs on neighboring subcarriers.
   BFWs on the remaining subcarriers may be obtained by interpolating the calculated BFWs, e.g. with linear interpolation.
   Two methods above may also be used jointly by partial interpolation and then repeat on neighboring subcarriers.
The RU 112 then performs beamforming with the determined BFWs on each subcarrier. This action is related to Action 505 described above.
   For DL, the BFWs may be used to perform beamforming of the user-layer symbols of the scheduled UEs, such as e.g. the UE 120.
   For UL, the BFWs may be used to perform beamforming of the received signals from different antennas/beams.

### Performance Evaluation

To illustrate advantages of embodiments herein, simulations has been performed as follows:
Channel realization in element-domain of 100 MHz with 60 kHz SCS, N=64 antennas and K=8 user-layers is used.
The size of SCG is 2 RBs.
Channel data is firstly transformed into beam-domain with DFT and then two sets of BFWs are calculated based on the channel data on the 6th and 18th subcarrier of each SCG. The calculated BFWs are then transformed into tap-domain BFWs using DCT with 10 MHz sub-band chunk.
The tap-domain BFWs are sent, also referred to as transported or transmitted, over the fronthaul interface is quantized with a 16-bit data format.
Both power per user-layer and power per antenna element are normalized when performing beamforming.
No beam selection is performed at the BBU 111.

In this example, the number of selected taps out of the tap-domain BFWs is determined based on how many subcarriers per SCG have the BFW calculation conducted at the BBU 111, to achieve higher compression than the reference method, i.e. over prior art. For example, if the BFW calculation is on 2 subcarriers per SCG, then at most 50% of taps are selected; if BFW calculation is on 4 subcarriers per SCG, then at most 25% of taps are selected. When calculating the BFWs, DL Reciprocity-Assisted Transmission is used.

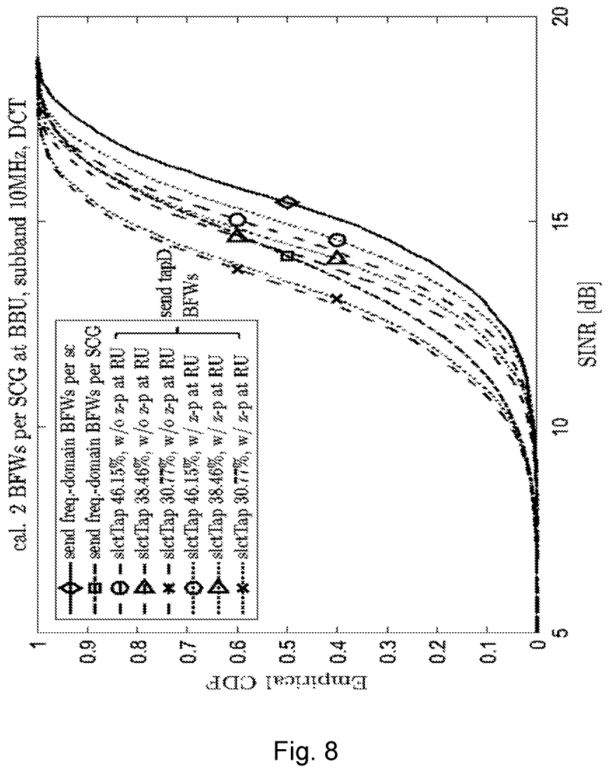

The SINR comparison without beam-selection at BBU 111 is shown in FIG. 8.
The solid and diamond-marked line shows the performance when frequency-domain BFWs on each Subcarrier (SC) is sent from the BBU 111 to the RU 112. It presents as the reference of best possible performance but needs much more BFWs data to be sent to the RU 112.
The dash-dotted and square-marked line shows the performance when frequency-domain BFWs on the middle subcarrier of each SCG is sent from the BBU 111 to the RU 112. It shows the performance of the reference method.
The three dashed lines and three solid lines show the performance when tap-domain BFWs is transported from BBU to RU. The circle, triangle and cross markers denote the performances when 46.15%, 38.46% and 30.77% of strongest taps are selected to be transmitted respectively, which achieves higher compression than the reference method as shown in FIG. 9. FIG. 9 depicts comparison of required fronthaul capacity between the reference method of sending frequency-domain BFWs per SCG and the method of sending selected tap-domain BFWs with different selection ratio 111 according to embodiments herein.
   The dashed lines in FIG. 8 show the performances when the IDCT at RU has the same input and output length (i.e., no zero-padding is conducted).
   The dotted lines show the performances when the IDCT at RU has the output length equal to the number of subcarriers within the 10 MHz sub-band (i.e., zero-padding is conducted before IDCT).

Receiving BFWs on more subcarriers will improve the beamforming performance at the RU 112. But for the reference method according to prior art, transmitting more BFWs means higher requirement on fronthaul capacity. Contrary to the reference method having the beamforming performance constrained by the fronthaul capability, the transmitting of BFWs in tap-domain according to embodiments herein, resulting in a largely alleviated constraint since the tap-domain BFWs have the energy concentrated in a small portion of taps. If the BFWs are calculated on more subcarriers and are transformed in tap-domain, by only transmitting those energy concentrating taps, the required fronthaul capacity will still be low, as shown in FIG. 9 which may be lower than the reference method, while most BFWs information has been maintained so that the performance improvement due to BFWs available on more subcarriers are still visible at the RU 112 as shown in FIG. 8. For the method according to embodiments herein, the number of selected tap domain BFWs shall preferably be carefully set so that it is not too small that would miss some significant taps and impacts the performance, as the selection ratio 30.77% in FIG. 8, but still be low enough to keep the advantage of saving fronthaul capacity. In addition, conducting additional zero-padding in the tap-domain before transforming back to frequency-domain may improve the performance, see, by comparing the dotted lines to the dashed lines in FIG. 8. It is not always needed to zero-pad to the full length of L, to obtain the BFWs of all subcarriers after transformation. In this example, it is also observed that having the Inverse DCT (IDCT) output length to be twice of the input length (not shown in the figure) may already achieve above performance of zero-padding to the full length of L.

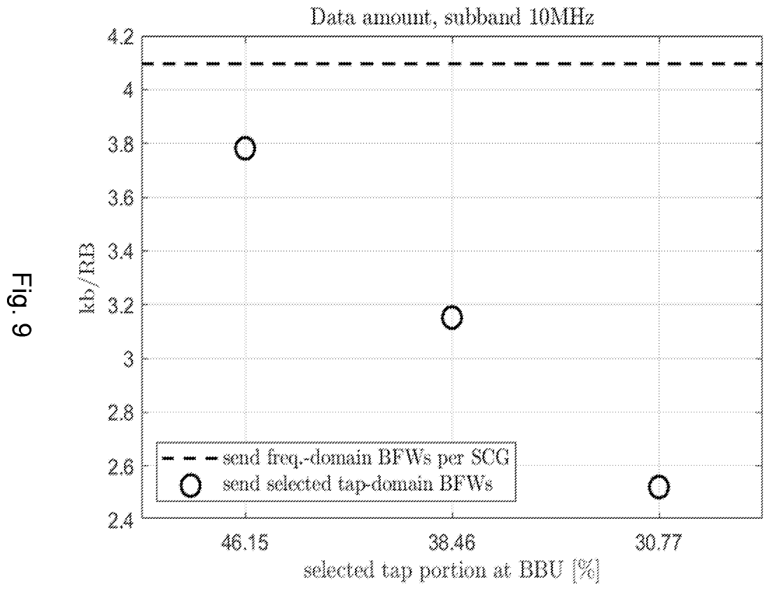

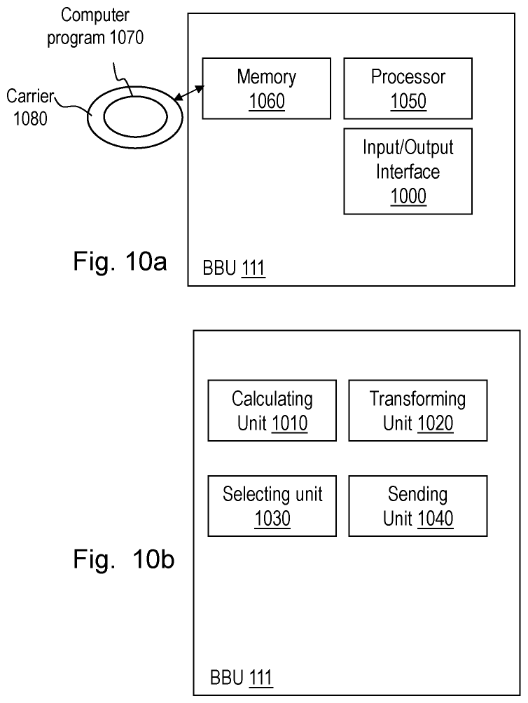

To perform the method actions above, the BBU 111 is configured to assist the RU, 112 to perform beamforming for a communication between the UE 120 and the base station 110 in the wireless communications network 100 using a multiple antenna system for communication. The BBU 111 and the RU 112 are adapted to be associated with the base station 110. The BBU 111 may comprise an arrangement depicted in FIGS. 10a and 10b.

The BBU 111 may comprise an input and output interface 900 configured to communicate with other network entities such as the RU 112. The input and output interface 900 may comprise a wireless receiver (not shown) and a wireless transmitter (not shown).

The BBU 111 is further configured to, e.g. by means of a calculating unit 1010 in the BBU 111, calculate respective BFWs for at least a subset of subcarriers out of a number of subcarriers.

The subset of subcarriers may be adapted to comprise subcarriers for which respective estimated channel data is available.

The BBU 111 is further configured to, e.g. by means of a transforming unit 1020 in the BBU 111, transform by a mathematical transformation, the respective calculated BFWs, from frequency domain BFWs to obtain tap-domain BFWs.

The BBU 111 is further configured to, e.g. by means of a selecting unit 1030 in the BBU 111, select one or more tap-domain BFWs from said obtained tap-domain BFWs.

The number of tap-domain BFWs of the selected one or more tap-domain BFWs, may be adapted to be selected based on a trade-off between: Being large enough to comprise significant tap-domain BFWs, and being low enough to save fronthaul capacity.

The selected one or more tap-domain BFWs may be adapted to be selected to comprise tap-domain BFWs with the largest magnitude.

The BBU 111 is further configured to, e.g. by means of a sending unit 1040 in the BBU 111, send to the RU 112, the selected one or more the tap-domain BFWs. The selected one or more tap-domain BFWs is adapted to assist the RU 112 to perform beamforming for the communication between the UE 120 and the base station 110.

The BBU 111 may send to the RU 112 information adapted to identify the selected one or more tap-domain BFWs. The information adapted to identify the selected one or more tap-domain BFWs may further be adapted to assist the RU 112 to perform beamforming for the communication between the UE 120 and the base station 110.

The embodiments herein may be implemented through a respective processor or one or more processors, such as the processor 1050 of a processing circuitry in the BBU 111 depicted in FIG. 10a, together with respective computer program code for performing the functions and actions of the embodiments herein. The program code mentioned above may also be provided as a computer program product, for instance in the form of a data carrier carrying computer program code for performing the embodiments herein when being loaded into the BBU 111. One such carrier may be in the form of a CD ROM disc. It is however feasible with other data carriers such as a memory stick. The computer program code may furthermore be provided as pure program code on a server and downloaded to the BBU 111.

The BBU 111 may further comprise a memory 1060 comprising one or more memory units. The memory 1060 comprises instructions executable by the processor in BBU 111. The memory 1060 is arranged to be used to store e.g. information, indices, channel data, indications, subcarriers, BFWs, data, configurations, and applications to perform the methods herein when being executed in the BBU 111.

In some embodiments, a computer program 1070 comprises instructions, which when executed by the respective at least one processor 1050, cause the at least one processor of the BBU 111 to perform the actions above.

In some embodiments, a respective carrier 1080 comprises the respective computer program 1070, wherein the carrier 1080 is one of an electronic signal, an optical signal, an electromagnetic signal, a magnetic signal, an electric signal, a radio signal, a microwave signal, or a computer-readable storage medium.

Those skilled in the art will appreciate that the units in the BBU 111 described above may refer to a combination of analog and digital circuits, and/or one or more processors configured with software and/or firmware, e.g. stored in the BBU 111, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

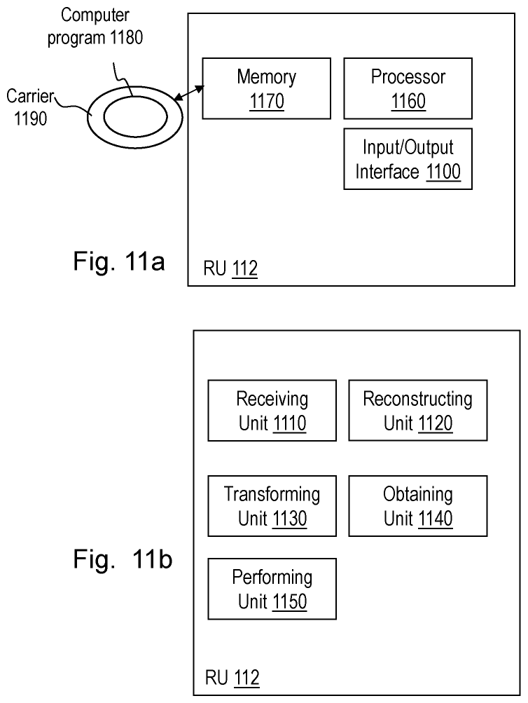

To perform the method actions above, the RU 112 is configured to perform beamforming for a communication between the UE 120 and the base station 110 in the wireless communications network 100 using a multiple antenna system for communication. The RU 112 is adapted to be associated with the base station 110. The RU 112 may comprise an arrangement depicted in FIGS. 11a and 11b.

The RU 112 may comprise an input and output interface 1100 configured to communicate with other network entities such as the UE 120 and the BBU 111. The input and output interface 1000 may comprise a wireless receiver (not shown) and a wireless transmitter (not shown).

The RU 112 is further configured to, e.g. by means of a receiving unit 1110 in the RU 112, receive from the BBU 111 adapted to be associated with the base station 110, one or more tap-domain BFWs selected by the BBU 111.

The RU 112 may receive from the BBU 111 information adapted to identify the selected one or more tap-domain BFWs.

The RU 112 is further configured to, e.g. by means of a reconstructing unit 1120 in the RU 112, reconstruct tap-domain BFWs based on the selected one or more tap-domain BFWs.

The RU 112 may reconstruct the tap-domain BFWs based on the information adapted to identify the selected one or more tap-domain BFWs.

The RU 112 may reconstruct the tap-domain BFWs of the selected one or more tap-domain BFWs by any one or more out of: Filling zeros at the positions of frequency domain BFWs that are unselected according to the received information adapted to identify the selected one or more tap-domain BFWs, and filling zeros at in the end of the tap-domain BFWs.

The RU 112 is further configured to, e.g. by means of a transforming unit 1130 in the RU 112, transform by a mathematical transformation, at least some of the reconstructed tap-domain BFWs of the one or more tap-domain BFWs, to obtain corresponding frequency domain BFWs. The frequency domain BFWs are adapted to be related to respective subcarriers out of a number of subcarriers.

The RU 112 may further be configured to, e.g. by means of an obtaining unit 1140 in the RU 112, when not frequency domain BFWs on all subcarriers has been obtained, obtain frequency domain BFWs on the remaining subcarriers out of the number of subcarriers based on the transformed frequency domain BFWs.

The RU (112) may obtain the frequency domain BFWs on the remaining subcarriers out of the number of subcarriers based on the transformed frequency domain BFWs, by any one or more out of:
(i) repeating the corresponding frequency domain BFWs on neighboring subcarriers.
(ii) interpolating the corresponding frequency domain BFWs.
(iii) combining (i) and (ii) by partial interpolation and then repeating on neighboring subcarriers.

The RU 112 is further configured to, e.g. by means of a performing unit 1150 in the RU 112, perform beamforming with the obtained frequency domain BFWs on the respective subcarriers out of the number of subcarriers for the communication between the UE 120 and the base station 110.

The embodiments herein may be implemented through a respective processor or one or more processors, such as the processor 1160 of a processing circuitry in the RU 112 depicted in FIG. 11a, together with respective computer program code for performing the functions and actions of the embodiments herein. The program code mentioned above may also be provided as a computer program product, for instance in the form of a data carrier carrying computer program code for performing the embodiments herein when being loaded into the RU 112. One such carrier may be in the form of a CD ROM disc. It is however feasible with other data carriers such as a memory stick. The computer program code may furthermore be provided as pure program code on a server and downloaded to the RU 112.

The RU 112 may further comprise a memory 1170 comprising one or more memory units. The memory 1170 comprises instructions executable by the processor in RU 112. The memory 1170 is arranged to be used to store e.g., information, indices, channel data, indications, subcarriers, BFWs, data, configurations, and applications to perform the methods herein when being executed in the RU 112.

In some embodiments, a computer program 1180 comprises instructions, which when executed by the respective at least one processor 1160, cause the at least one processor of the RU 112 to perform the actions above.

In some embodiments, a respective carrier 1190 comprises the respective computer program 1180, wherein the carrier 1190 is one of an electronic signal, an optical signal, an electromagnetic signal, a magnetic signal, an electric signal, a radio signal, a microwave signal, or a computer-readable storage medium.

Those skilled in the art will appreciate that the units in the RU 112 described above may refer to a combination of analog and digital circuits, and/or one or more processors configured with software and/or firmware, e.g., stored in the RU 112, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

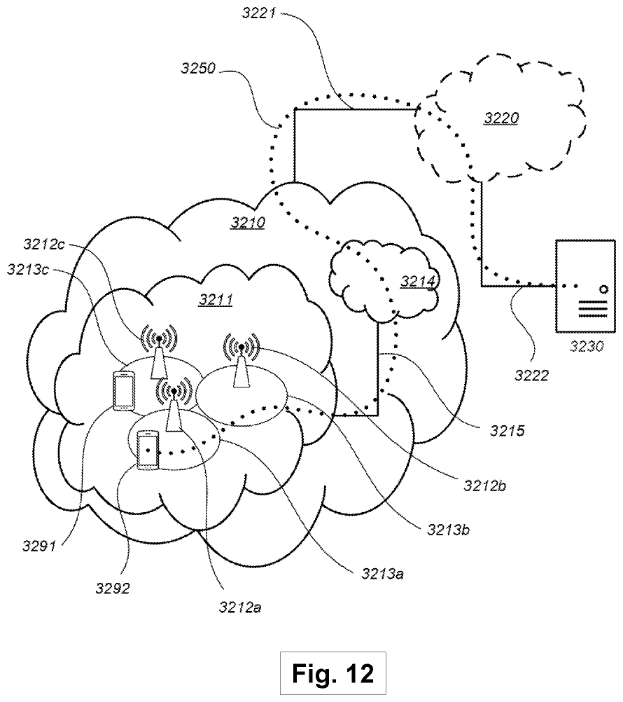

With reference to FIG. 12, in accordance with an embodiment, a communication system includes a telecommunication network 3210, such as a 3GPP-type cellular network, e.g., wireless communications network 100, which comprises an access network 3211, such as a radio access network, and a core network 3214. The access network 3211 comprises a plurality of base stations 3212a, 3212b, 3212c, such as AP STAs NBs, eNBs, gNBs, e.g., base station 110, or other types of wireless access points, each defining a corresponding coverage area 3213a, 3213b, 3213c. Each base station 3212a, 3212b, 3212c is connectable to the core network 3214 over a wired or wireless connection 3215. A first UE such as a Non-AP STA 3291, e.g. UE 120, located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

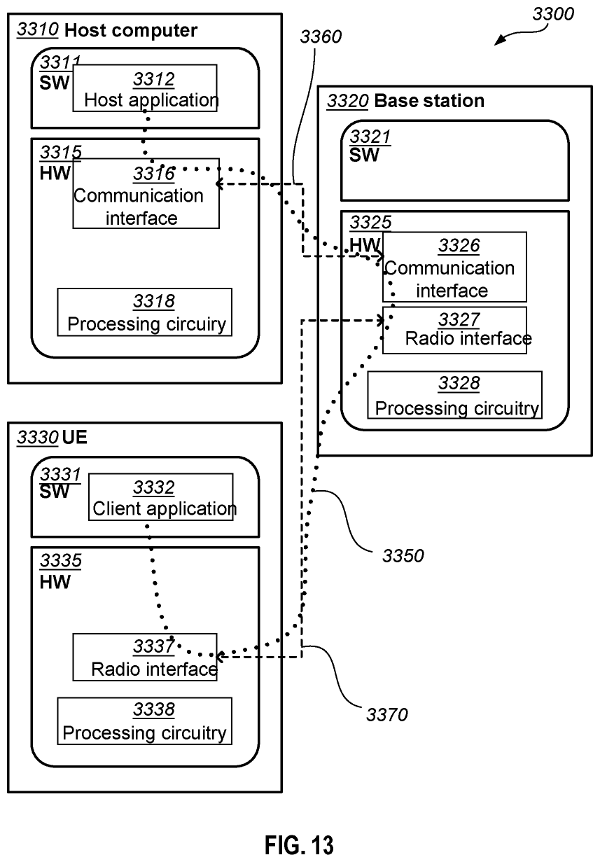

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

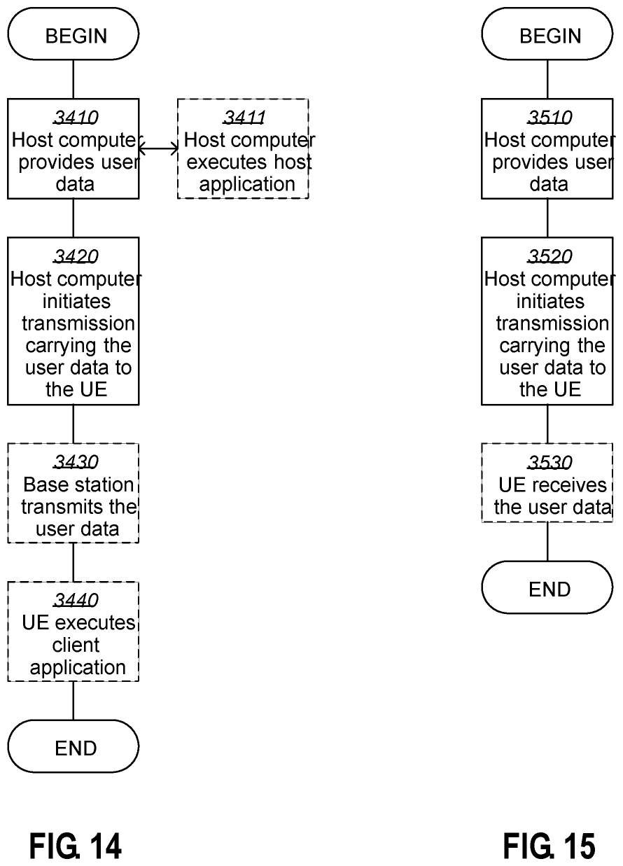

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

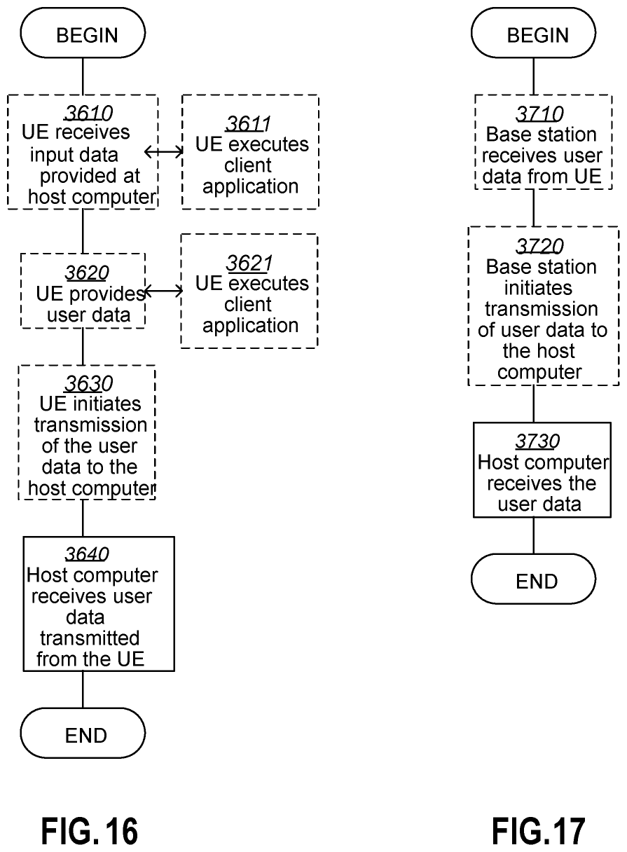

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 16 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a Baseband Unit, BBU, (111) for assisting a Radio Unit, RU, (112) to perform beamforming for a communication between a User Equipment, UE, (120) and a base station (110) in a wireless communications network (100) using a multiple antenna system for communication, wherein the BBU (111) and the RU (112) are associated with the base station (110), the method comprising:
calculating (401) respective Beamforming Weights, BFWs, for at least a subset of subcarriers out of a number of subcarriers,
transforming (402) by a mathematical transformation, the respective calculated BFWs, from frequency domain BFWs to obtain tap-domain BFWs,
selecting (403) one or more tap-domain BFWs from said obtained tap-domain BFWs, and
sending (404) to the RU (112), the selected one or more the tap-domain BFWs, which selected one or more tap-domain BFWs assist the RU (112) to perform beamforming for the communication between the UE (120) and the base station (110).

2. The method according to claim 1, wherein the sending (404) to the RU (112), further comprises:
information identifying the selected one or more tap-domain BFWs, which information identifying the selected one or more tap-domain BFWs further assist the RU (112) to perform beamforming for the communication between the UE (120) and the base station (110).

3. The method according to claim 1, wherein the number of tap-domain BFWs of the selected one or more tap-domain BFWs, is selected based on a trade-off between:
being large enough to comprise significant tap-domain BFWs, and
being low enough to save fronthaul capacity.

4. The method according to claim 1, wherein the selected one or more tap-domain BFWs are selected to comprise tap-domain BFWs with one or more largest magnitude.

5. The method according to claim 1, wherein the subset of subcarriers comprises subcarriers for which respective estimated channel data is available.

6. A computer program (1070) comprising instructions, which when executed by a processor (1050), causes the processor (1050) to perform actions according to claim 1.

7. A carrier (1080) comprising the computer program (1070) of claim 6, wherein the carrier (1080) is one of an electronic signal, an optical signal, an electromagnetic signal, a magnetic signal, an electric signal, a radio signal, a microwave signal, or a computer-readable storage medium.

8. A method performed by a Radio Unit, RU, (112) for performing beamforming for a communication between a User Equipment, UE, (120) and a base station (110) in a wireless communications network (100) using a multiple antenna system for communication, wherein the RU (112) is associated with the base station (110), the method comprising:
receiving (501) from a Base Band Unit, BBU, (111) associated with the base station (110), one or more tap-domain BFWs selected by the BBU (111),
reconstructing (502) tap-domain BFWs based on the selected one or more tap-domain BFWs,
transforming (503) by a mathematical transformation, at least some of the reconstructed tap-domain BFWs of the one or more tap-domain BFWs, to obtain corresponding frequency domain BFWs related to respective subcarriers out of a number of subcarriers, and
performing (505) beamforming with the obtained frequency domain BFWs on the respective subcarriers out of the number of subcarriers for the communication between the UE (120) and the base station (110).

9. The method according to claim 8, wherein the receiving (501) from the BBU, (111), further comprises:
receiving information identifying the selected one or more tap-domain BFWs.

10. The method according to claim 8, wherein the reconstructing (502) of the tap-domain BFWs of the selected one or more tap-domain BFWs further comprises any one or more out of:
filling zeros at the positions of frequency domain BFWs that are unselected according to the received information identifying the selected one or more tap-domain BFWs, and
filling zeros at in the end of the tap-domain BFWs.

11. The method according to claim 8, further comprising:
when not frequency domain BFWs on all subcarriers has been obtained, obtaining (504) frequency domain BFWs on the remaining subcarriers out of the number of subcarriers based on the transformed frequency domain BFWs.

12. The method according to claim 11, wherein the obtaining (504) of the frequency domain BFWs on the remaining subcarriers out of the number of subcarriers based on the transformed frequency domain BFWs, is performed by any one or more out of:
(i) repeating the corresponding frequency domain BFWs on neighboring subcarriers.
(ii) interpolating the corresponding frequency domain BFWs.
(iii) combining (i) and (ii) by partial interpolation and then repeating on neighboring subcarriers.

13. A computer program (1180) comprising instructions, which when executed by a processor (1160), causes the processor (1160) to perform actions according to claim 8.

14. A carrier (1190) comprising the computer program (1180) of claim 13, wherein the carrier (1190) is one of an electronic signal, an optical signal, an electromagnetic signal, a magnetic signal, an electric signal, a radio signal, a microwave signal, or a computer-readable storage medium.

15. A Baseband Unit, BBU, (111) configured to assist a Radio Unit, RU, (112) to perform beamforming for a communication between a User Equipment, UE, (120) and a base station (110) in a wireless communications network (100) using a multiple antenna system for communication, wherein the BBU (111) and the RU (112) are adapted to be associated with the base station (110), wherein the BBU (111) is further configured to:
calculate respective Beamforming Weights, BFWs, for at least a subset of subcarriers out of a number of subcarriers,
transform by a mathematical transformation, the respective calculated BFWs, from frequency domain BFWs to obtain tap-domain BFWs,
select one or more tap-domain BFWs from said obtained tap-domain BFWs, and
send to the RU (112), the selected one or more the tap-domain BFWs, which selected one or more tap-domain BFWs is adapted to assist the RU (112) to perform beamforming for the communication between the UE (120) and the base station (110).

16. The BBU (111) according to claim 15, wherein the wherein the BBU (111) is further configured to send to the RU (112):
information adapted to identify the selected one or more tap-domain BFWs, which information adapted to identify the selected one or more tap-domain BFWs further is adapted to assist the RU (112) to perform beamforming for the communication between the UE (120) and the base station (110).

17. The BBU (111) according to claim 15, wherein the number of tap-domain BFWs of the selected one or more tap-domain BFWs, is adapted to be selected based on a trade-off between:
being large enough to comprise significant tap-domain BFWs, and
being low enough to save fronthaul capacity.

18. The BBU (111) according to claim 15, wherein the selected one or more tap-domain BFWs are adapted to be selected to comprise tap-domain BFWs with the largest magnitude.

19. The BBU (111) according to claim 15, wherein the subset of subcarriers is adapted to comprise subcarriers for which respective estimated channel data is available.

20.-24. (canceled)

25. The method according to claim 9, wherein the reconstructing (502) the tap-domain BFWs is based on the information identifying the selected one or more tap-domain BFWs.
